(19) United States
(12) Patent Application Publication
(10) Pub. No.: US 2025/0381709 A1
(43) Pub. Date: Dec. 18, 2025

(54) PLASTIC RECYCLING PROCESS

(71) Applicant: SHENGSHI ECOTECHNOLOGY CO., LTD., New Taipei City (TW)

(72) Inventors: SHU-ANG LEE, Taipei City (TW); Chihhao FAN, Taipei City (TW); Jhen-Nan LIN, Taipei City (TW); Ya-Zen HUANG, Taipei City (TW)

(21) Appl. No.: 18/879,119

(22) PCT Filed: May 31, 2023
(86) PCT No.: PCT/CA2023/050748

§ 371 Date: Dec. 26, 2024

(30) Foreign Application Priority Data
Jul. 4, 2022 (JP) 2022-107681

(51) Int. Cl. B29B 17/02

(52) U.S. Cl. CPC B29B 17/02; B29B 2017/0224; B29B 2017/0244

(57) ABSTRACT

The present invention provides a plastic recycling process, which firstly adopts a solvent along with a heating step to dissolve a recycle target, and then adopts a negative pressure environment to separate the solvent and the recycle target. The plastic recycling process of the present invention has a high plastic recovery rate, and the solvent is reusable and can be recycled, which not only reduces costs, but also avoids potential environmental problems.

### BACKGROUND OF THE INVENTION

### 1. Field of the Invention

The present invention relates to a plastic recycling process, especially a plastic recycling process for polypropylene.

### 2. Description of the Prior Arts

Plastics were invented in the 19th century. As plastics have the advantages of high stability property and low production cost, they are popular raw materials for daily necessities. For example, polypropylene (PP) has the advantages of heat resistance, acid/alkali resistance and good toughness, so it is widely used for the production of beverage bottles, straws, microwave safe containers and trash cans, etc. In addition, PP has a lower carcinogenic risk in comparison with other plastic materials, so it is widely used in food containers.

As plastics hardly decompose in the natural environment, they become the cause of environmental problems, especially the containers, e.g. disposable plastic bags or polyethylene terephthalate (PET) bottles. The current plastic recycling process comprises: (1) melting regeneration method: clean leftover materials from the factories are collected and reshaped, or various plastics are collected and mixed to obtain a post-consumer recycled plastic; and (2) pyrolysis: specific plastics are collected and turned into fuels. For example, patent TWI254115B discloses the method to produce liquid oils and fuel gases from waste plastics by decomposition and transmutation.

While the policies for plastic reduction are implemented by most of the countries, the environmental problems caused by plastic waste are still imminent. Hence, there is a necessity to develop a new plastic recycling process.

### SUMMARY OF THE INVENTION

To solve the aforementioned problem, the present invention provides a plastic recycling process, comprising:
(1) preparation step: providing a material containing plastics, wherein the material containing plastics comprises a plastic ingredient, and the plastic ingredient comprises polypropylene (PP);
(2) mixing step: mixing the material containing plastics and a solvent to obtain a first mixture, wherein the plastic ingredient is soluble in the solvent;
(3) heating step: heating and stirring the first mixture at a temperature of 80° C. to 140° C. to dissolve the plastic ingredient in the solvent, thereby obtaining a dissolved liquid; and
(4) separation step: putting the dissolved liquid in a negative pressure environment to obtain the plastic ingredient.

According to the present invention, first, the dissolution of the recycling plastic target by solvents can achieve high recovery rate. Second, both heating and stirring facilitate dissolution and increase the plastic recovery rate. Third, the evaporation of solvents in the negative pressure environment can (1) effectively separate solvents and the recovered plastic target; and (2) prevent the solvents or the recovered plastic target from deteriorating due to overheating. As the solvent is reusable, the recycle of solvents can (1) further reduce recycling costs for plastic recycling and attract more manufacturers to invest in plastic recycling industry; and (2) avoid the cost increase and potential environmental problems caused by the discharge of solvents. Hence, the present invention can reduce environmental problems in two aspects: encouraging recycling and reducing discharge of chemical waste.

The material containing plastics of the present invention comprises polymers, mixtures or a combination thereof.

According to the present invention, when the temperature of the heating in the heating step is greater than 140° C., the dissolved liquid begins boiling.

In one embodiment, the separation step further comprises: keeping the dissolved liquid at a temperature of 70° C. to 100° C. The present invention takes advantage of a negative pressure environment to lower the boiling point of the solvent, and keeps the solvent in a boiling state by keeping the temperature of the solvent, so that the recycle of solvents requires less energy and can be accelerated and carried out steadily.

In one embodiment, in the separation step, the pressure of the negative pressure environment is greater than or equal to 0 mbar and less than or equal to 90 mbar, such as: 1 mbar, 10 mbar, 30 mbar, 50 mbar, 70 mbar or 90 mbar. Preferably, the pressure of the negative pressure environment is greater than or equal to 0 mbar and less than or equal to 20 mbar.

In one embodiment, the time for the separation step is 5 minutes to 1 hour. Preferably, when the pressure of the negative pressure environment is greater than or equal to 0 mbar and less than or equal to 20 mbar, the time for the separation step is 10 minutes to 20 minutes; and/or when the pressure of the negative pressure environment is greater than 20 mbar and less than or equal to 80 mbar, the time for the separation step is 20 minutes to 40 minutes.

In one embodiment, the plastic recycling process of the present invention does not use a precipitant to separate the plastic ingredient.

In one embodiment, the solvent comprises an aromatic hydrocarbon, a ketone, an ether, a naphthene hydrocarbon, an ester or a combination thereof.

Preferably, the ester comprises an alkyl ester.

Preferably, the aromatic hydrocarbon comprises benzole, toluene, xylene, tetralin, decalin or a combination thereof.

For xylene, it has the advantage of a relatively low toxicity.

In one embodiment, the mixing step further comprises: adding a non-solvent, and the non-solvent comprises an ether, a ketone, an ester or a combination thereof.

Preferably, the ether comprises tetrahydrofuran.

Preferably, the ketone comprises cyclohexanone, acetone or a combination thereof.

Preferably, the ester comprises propylene glycol methyl ether acetate, butyl acetate, isoamyl acetate or a combination thereof.

According to the present invention, the non-solvent means a liquid which is soluble with the solvent, and the addition of the non-solvent can reduce the required amount of solvents and maintain a high recovery rate, which facilitates reducing costs and toxicity, and enhancing environmental friendliness.

In one embodiment, the difference between the solubility parameter of the non-solvent and that of the solvent is greater than or equal to 0 and less than or equal to 2, such as: 0.1, 0.3, 0.5, 0.7, 0.9, 1.1, 1.3, 1.5, 1.7, 1.9 or 2 for the improvement of the dissolution effect. Preferably, the difference between the solubility parameter of the non-solvent and that of the solvent is greater than or equal to 0 and less than or equal to 0.5.

The solubility parameter is a physical constant to indicate the compatibility of liquid materials, and the physical meaning thereof is the square root of the cohesive energy density of the material.

In one embodiment, the plastic ingredient of the present invention hardly dissolves in the non-solvent. Preferably, the plastic ingredient is substantially insoluble in the non-solvent. More preferably, the plastic ingredient is insoluble in the non-solvent.

The term “hardly dissolve” means the plastic ingredient of the present invention is substantially insoluble in the non-solvent at the temperature of 80° C. to 140° C., and within the time less than or equal to 40 minutes.

In one embodiment, based on the total volume of the solvent and the non-solvent, the solvent is in a volume of 45 volume percent to 60 volume percent, such as: 45 volume percent, 48 volume percent, 51 volume percent, 53 volume percent, 56 volume percent, 59 volume percent or 60 volume percent; and the non-solvent is in a volume of 40 volume percent to 55 volume percent, such as: 40 volume percent, 41 volume percent, 44 volume percent, 47 volume percent, 49 volume percent, 52 volume percent or 55 volume percent.

Preferably, based on the total volume of the solvent and the non-solvent, the solvent is in a volume of 48 volume percent to 52 volume percent, and the non-solvent is in a volume of 48 volume percent to 52 volume percent. More preferably, based on the total volume of the solvent and the non-solvent, the solvent is in a volume of 50 volume percent, and the non-solvent is in a volume of 50 volume percent.

In one embodiment, the ratio of the volume of the solvent and that of the non-solvent is 0.8 to 1.5; such as: 0.8, 1.0, 1.2, 1.4 or 1.5. For example, when the solvent is in a volume of 100 ml, and the non-solvent is in a volume of 100 ml, the ratio of the volume of the solvent and that of the non-solvent is 1; or when the solvent is in a volume of 120 ml, and the non-solvent is in a volume of 100 ml, the ratio of the volume of the solvent and that of the non-solvent is 1.2.

In one embodiment, there are multiple materials containing plastics, and the multiple materials containing plastics have different specific weights.

Before or in the preparation step, the plastic recycling process of the present invention further comprises a sorting step: providing multiple sorting solutions which have different specific weights for floating and separating the multiple materials containing plastics having different specific weights.

Preferably, the multiple materials containing plastics are put into and separated in the multiple sorting solutions in the order from a low specific weight to a high specific weight in the sorting step. For example, the first sorting solution having a specific weight of 0.8, the second sorting solution having a specific weight of 1.0, and the third sorting solution having a specific weight of 1.2 are prepared, and the multiple materials containing plastics are firstly put into the first sorting solution to obtain a first floating part and a first sediment part. The first sediment part is further put into the second sorting solution to obtain a second floating part and a second sediment part. Finally, the second sediment part is further put into the third sorting solution to obtain a third floating part and a third sediment part, wherein the first floating part, the second floating part, the third floating part and the third sediment part each have different specific weights.

In one embodiment, the specific weights of the multiple sorting solutions is from 0.8 to 1.6, such as: 0.8, 1.0, 1.2, 1.4 or 1.6. For example, the multiple materials containing plastics are put into and separated in the multiple sorting solutions having the specific weights of 0.8, 0.9, 1.0, 1.1, 1.2, 1.3, 1.4, 1.5 and 1.6 in sequence. Preferably, the specific weights of the multiple sorting solutions are from 0.8 to 1.0. More preferably, the specific weights of the multiple sorting solutions are from 0.8 to 0.9. The present invention can effectively screen out materials containing no or little polypropylene by the sorting step to improve the recovery efficiency of polypropylene.

In one embodiment, the material containing plastics is in a form of particles.

Preferably, the average diameter of the material containing plastics in the form of particles is greater than 0 mm and less than or equal to 5 mm, such as: 1 mm, 2 mm, 3 mm, 4 mm or 5 mm.

In the heating step of the present invention, the temperature of the heating is from 80° C. to 140° C., such as: 80° C., 100° C., 120° C. or 140° C. Preferably, the temperature of the heating in the heating step is 130° C. to 140° C., such as: 130° C., 133° C., 136° C., 139° C. or 140° C.

In one embodiment, the stirring in the heating step is conducted at a speed of 15 rpm to 40 rpm, such as: 15 rpm, 20 rpm, 25 rpm, 30 rpm, 35 rpm or 40 rpm. The present invention takes advantage of the stirring to keep the material containing plastics suspended in the solvent, thereby enhancing the dissolution efficiency and recovery rate.

In one embodiment, the stirring in the heating step is conducted for 15 minutes to 60 minutes, such as: 15 minutes, 20 minutes, 30 minutes, 40 minutes, 50 minutes or 60 minutes.

In one embodiment, based on a volume of 100 ml of the solvent, the weight of the material containing plastics is greater than 0 g and less than or equal to 2.2 g, such as: 0.05 g, 0.1 g, 0.15 g, 0.2 g, 0.25 g, 0.3 g, 0.35 g, 0.4 g, 0.5 g, 0.6 g, 0.7 g, 0.8 g, 0.9 g, 1.0 g, 1.1 g, 1.2 g, 1.3 g, 1.4 g, 1.5 g, 1.6 g, 1.7 g, 1.8 g, 1.9 g, 2.0 g, 2.1 g or 2.2 g. Preferably, based on a volume of 100 ml of the solvent, the weight of the material containing plastics is 1.4 g to 1.6 g. According to the present invention, said weight ratio range of the material containing plastics based on the volume of the solvent results in two advantages: (1) said weight ratio range makes the first mixture easier for stirring; and (2) said weight ratio range increases the plastic recovery rate.

In one embodiment, based on a total volume of 100 ml of the solvent and the non-solvent, the weight of the material containing plastics is greater than 0 g and less than or equal to 2.2 g, such as: 0.05 g, 0.1 g, 0.15 g, 0.2 g, 0.25 g, 0.3 g, 0.35 g, 0.4 g, 0.5 g, 0.6 g, 0.7 g, 0.8 g, 0.9 g, 1.0 g, 1.1 g, 1.2 g, 1.3 g, 1.4 g, 1.5 g, 1.6 g, 1.7 g, 1.8 g, 1.9 g, 2.0 g, 2.1 g or 2.2 g. Preferably, based on a total volume of 100 ml of the solvent and the non-solvent, the weight of the material containing plastics is 1.4 g to 1.6 g. According to the present invention, said weight ratio range of the material containing plastics based on the volume of the solvent results in two advantages: (1) said weight ratio range makes the first mixture easier for stirring; and (2) said weight ratio range increases the plastic recovery rate.

In one embodiment, the step (3) heating step comprises: step (3-1): heating and stirring the first mixture at the temperature of 80° C. to 140° C. to dissolve the plastic ingredient in the solvent, thereby obtaining a second mixture; and step (3-2): filtering the second mixture with a filter screen, thereby obtaining a dissolved liquid. The present invention removes insoluble impurities in the solvent by filtering to increase the purity of the recovered product.

In one embodiment, the step (3-2) further comprises a sedimentation step: A. after obtaining the second mixture, keeping the second mixture still to obtain a stilled second mixture, wherein the temperature of the stilled second mixture is lower than that of the second mixture, and the stilled second mixture comprises a supernatant and a sediment; and B. filtering the supernatant to remove impurities thereof with a filter screen, thereby obtaining the dissolved liquid. In other words, the present invention can further adopt the sedimentation step, which keeps the second mixture still without heating and then removes undissolved ingredients and suspended solids with a filter screen for removing impurities.

Preferably, in the sedimentation step, the time for keeping the second mixture still is 2 to 3 hours. The present invention firstly keeps the second mixture still at room temperature to obtain a stilled second mixture. When the stilled second mixture shows obvious sedimentation, that is, the stilled second mixture comprises a supernatant and a sediment, the supernatant is further filtered with a filter screen. In comparison with filtering the second mixture directly, filtering the supernatant thereof can shorten the time required for filtration and reduce the amount of impurities in the dissolved liquid.

To sum up, the plastic recycling process of the present invention has a high plastic recovery rate, and the solvent and the non-solvent are reusable and can be recycled, which not only reduces costs, but also avoids potential environmental problems.

### BRIEF DESCRIPTION OF THE DRAWINGS

FIG. 1 and FIG. 2 are flow charts of the plastic recycling process of the present invention.

### DETAILED DESCRIPTION OF THE PREFERRED EMBODIMENTS

The present invention is further explained through the following embodiments. A person having ordinary skill in the art can easily understand the advantages and efficacies achieved by the present invention. The present invention should not be limited to the contents of the embodiments. A person having ordinary skill in the art can make some improvement or modifications which are not departing from the spirit and scope of the present invention to practice or apply the content of the present invention.

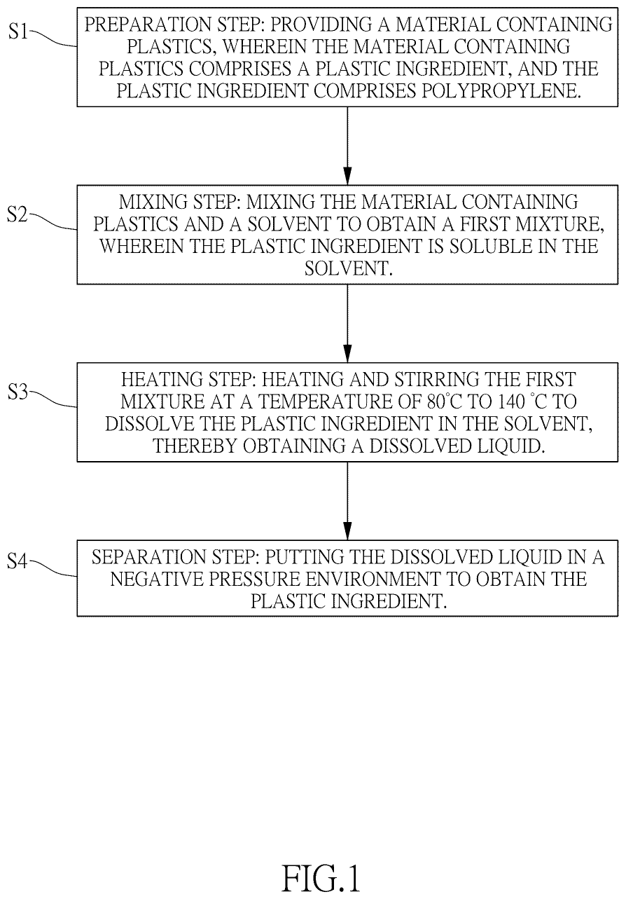

As shown in FIG. 1, first, the plastic recycling process of the present invention comprises step S1: preparation step: providing a material containing plastics, the material containing plastics comprises a plastic ingredient, and the plastic ingredient comprises polypropylene. Specifically, the materials containing plastics are particles obtained by crushing and sieving the industrial waste containing polypropylene. For example, the material containing plastics in the form of particles with a diameter of 2 mm or less is obtained by sieving with a 10-mesh sieve.

Second, the plastic recycling process of the present invention comprises step S2: mixing step: mixing the material containing plastics and a solvent to obtain a first mixture, wherein the plastic ingredient is soluble in the solvent. Specifically, the solvent is xylene, and the material containing plastics and xylene are mixed to obtain a first mixture.

Third, the plastic recycling process of the present invention comprises step S3: heating step: heating and stirring the first mixture at the temperature of 80° C. to 140° C. to dissolve the plastic ingredient in the solvent, thereby obtaining a dissolved liquid. Specifically, the temperature of the heating in the heating step is 140° C., the speed of the stirring is 20 rpm to 30 rpm, and the time for the heating step is 20 minutes to 40 minutes. Specifically, the heating step adopts a heating temperature of 140° C., a stirring speed of 20 rpm to 30 rpm, and a time of 20 minutes to 40 minutes.

Finally, the plastic recycling process of the present invention comprises step S4: separation step: putting the dissolved liquid in a negative pressure environment to obtain the plastic ingredient. Specifically, the dissolved liquid is transferred to and sealed in a vacuum concentration machine, and the vacuum function is initiated to form a negative pressure environment, so that the dissolved liquid begins to boil and xylene is evaporated for separation to obtain flake or granular polypropylene.

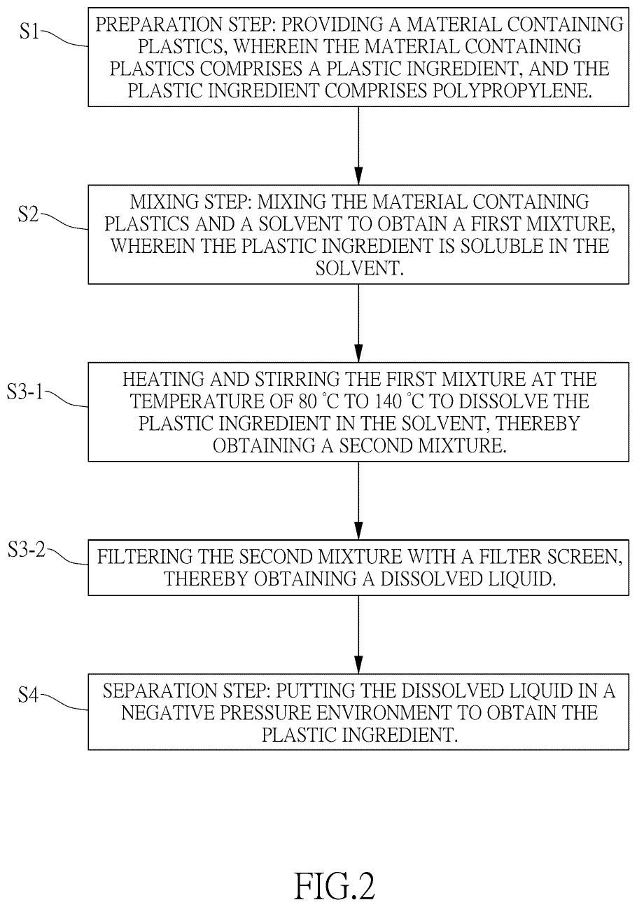

As shown in FIG. 1 and FIG. 2, when the material containing plastics is the industrial waste containing polypropylene, which contains ingredients that are insoluble in the solvent, the step S3 heating step comprises: S3-1: heating and stirring the first mixture at the temperature of 80° C. to 140° C. to dissolve the plastic ingredient in the solvent, thereby obtaining a second mixture; and S3-2: filtering the second mixture with a filter screen, thereby obtaining a dissolved liquid. Specifically, a filter screen is used to remove undissolved solids for removing impurities. In addition, before removing the undissolved solids with a filter screen, the second mixture stands still at room temperature to become a stilled second mixture. When the stilled second mixture shows obvious sedimentation, that is, the stilled second mixture comprises a supernatant and a sediment, the supernatant is collected for further filtering to increase purity.

### Test 1 and Test 2: The Solvent Recovery Condition Test

The step (4) separation step of the present invention comprises: putting the dissolved liquid in a negative pressure environment to obtain the plastic ingredient, so the pressure and corresponding recovery time were tested. The procedures were shown as follows: 200 ml of xylene liquid, which served as the solvent, was poured into the sample bottle, and the sample bottle containing the xylene liquid was placed into a negative pressure environment, which is a vacuum decompression concentrator, to simulate the step (4) separation step of the present invention. The sample bottles of Test 1 and Test 2 were both heated in a water bath in the vacuum decompression concentrator, wherein the temperature of the water bath was set at 80° C., and the rotation speed of the sample bottle was set at 20 rpm. The pressure was measured by the pressure gauge equipped on the vacuum pump, and the time to evaporate all 200 ml of xylene liquid by the water bath from room temperature was recorded. The results were shown in Table 1. For clarification, the function of the vacuum pump was simply air extraction, as it was difficult to control the pressure accurately for the negative pressure environment, so only two groups divided by 20 mbar were available for testing.

TABLE 1
the pressure of the negative pressure environment, the evaporation
time and the solvent recovery rate of Test 1 and Test 2

| | The pressure of the | | |
|---|---|---|---|
| | negative pressure | The evaporation | The solvent |
| Groups | environment | time | recovery rate |
| Test 1 | Greater than 20 mbar to | 30 minutes | >98% |
| | 80 mbar | | |
| Test 2 | 0 mbar to 20 mbar | 15 minutes | >98% |

As shown in Table 1, the pressure of the negative pressure environment of Test 1 was greater than 20 mbar to 80 mbar, which was about 2% to 8% of the atmospheric pressure (1.013 bar), and the required evaporation time was about 30 minutes. The pressure of the negative pressure environment of Test 2 was 0 mbar to 20 mbar, which was about 0% to 2% of atmospheric pressure (1.013 bar), and the required evaporation time was about 15 minutes. The solvent recovery rates of Test 1 and Test 2 were both greater than 98%. Therefore, reducing the pressure of the negative pressure environment can greatly reduce the time required for the step (4) separation step of the present invention without jeopardizing the recovery rate of the solvent, thereby improving recovery efficiency.

### Example 1 to Example 7

The materials containing plastics, the solvents and the non-solvents in Example 1 to Example 7 were shown in Table 2. First, the materials containing plastics were firstly crushed with a crushing device, and then sieved with a sieve with 10 meshes to obtain the materials containing plastics in the form of particles with a diameter of less than 2 mm. 3 g of the materials containing plastics in the form of particles were added into a solvent (or a mixed solution containing the solvent and the non-solvent) to obtain the first mixture. Further, the first mixture was heated to 140° C. by an electric furnace, and stirred at 20 rpm to 30 rpm during the heating process. When the temperature of the first mixture reached 140° C., the first mixture was stirred at 140° C. for another 20 minutes to 40 minutes to dissolve the material containing plastics in the form of particles for obtaining a dissolved liquid. The dissolved liquid was transferred to the vacuum decompression concentrator, and the dissolved liquid was heated by water bath at 90° C. The switch for water flow of the condensation pipe was turned on. After the vacuum decompression concentrator is sealed, the vacuum pump was turned on to reduce the pressure in the vacuum decompression concentrator to reach 0 mbar to 20 mbar. When the dissolved liquid began to boil or evaporate, the vacuum pump was turned off. The vapor of the solvent (and the non-solvent) was condensed by the condensation pipe and collected to recover the solvent (and the non-solvent), meanwhile, the pressure in the vacuum decompression concentrator was refrained from rising. Finally, after all the solvent (and the non-solvent) was evaporated, solid polypropylene in the form of flakes or granules was collected and rinsed with water to remove the residual odor of xylene, and further air-dried to obtain a recycled polypropylene. The weight of the recycled polypropylene was measured, and the appearance of the recycled polypropylene was inspected as well, the results were shown in Table 3. For clarification, the aforementioned mixed solution containing the solvent and the non-solvent can also be recycled and reusable directly without separation. Alternatively, as the solvent and the non-solvent have different boiling points, they can also be separated accordingly.

The solvent (and the non-solvent) recovered was reusable and in a clarified state. In addition, Example 5 to Example 7 of the present invention adopted industrial waste containing polypropylene, so they contained ingredients insoluble in the solvent. Therefore, between the heating step and the separation step, another filtration step was carried out: After the first mixture was heated and stirred to obtain a second mixture, the second mixture was further filtered with a 500-mesh stainless steel sieve to remove solids with a diameter of greater than 25 microns. In addition, before filtering the second mixture, keeping the second mixture still at room temperature for 2.5 hours to obtain a stilled second mixture. When the stilled second mixture showed obvious sedimentation after cooling and comprised a supernatant and a sediment, the supernatant was collected and filtered. For clarification, before the industrial wastes containing polypropylene in Examples 5 to 7 were dissolved, they were firstly confirmed to have polypropylene by optical method and cleaned by a strong oxidant to remove residual organic matter and impurities.

TABLE 2
the material containing plastics, the solvent
and the non-solvent in Example 1 to Example 7

| | Material | Solvent | | Non-solvent | |
|---|---|---|---|---|---|
| | containing | | Volume | | Volume |
| Groups | plastics | Ingredient | (ml) | Ingredient | (ml) |
| Example | commercial | xylene | 200 | N/A | 0 |
| 1 | polypropylene | | | | |
| Example | commercial | xylene | 100 | tetrahydro- | 100 |
| 2 | polypropylene | | | furan | |
| Example | commercial | xylene | 100 | cyclohexa- | 100 |
| 3 | polypropylene | | | none | |
| Example | commercial | xylene | 100 | acetone | 100 |
| 4 | polypropylene | | | | |
| Example | industrial | xylene | 200 | N/A | 0 |
| 5 | waste | | | | |
| | containing | | | | |
| | polypropylene | | | | |
| Example | industrial | xylene | 200 | N/A | 0 |
| 6 | waste | | | | |
| | containing | | | | |
| | polypropylene | | | | |
| Example | industrial | xylene | 200 | N/A | 0 |
| 7 | waste | | | | |
| | containing | | | | |
| | polypropylene | | | | |

TABLE 3
the recovery weight, recovery rate and appearance of polypropylene,
and the recovery rate of the solvent in Example 1 to Example 7

| | Polypropylene | | | Solvent |
|---|---|---|---|---|
| | Recovery | Recovery | | Recovery |
| Groups | weight | rate | Appearance | rate |
| Example 1 | 2.81 g | 93.7% | Except the shape was in a form | >90% |
| | | | of particles or flakes, other | |
| | | | appearance features were | |
| | | | similar to those of the | |
| | | | commercial polypropylene. | |
| Example 2 | 2.73 g | 91% | Except the shape was in a form | >90% |
| | | | of particles or flakes, other | |
| | | | appearance features were | |
| | | | similar to those of the | |
| | | | commercial polypropylene. | |
| Example 3 | 2.78 g | 92.7% | Except the shape was in a form | >95% |
| | | | of particles or flakes, other | |
| | | | appearance features were | |
| | | | similar to those of the | |
| | | | commercial polypropylene. | |
| Example 4 | 2.77 g | 92.3% | Except the shape was in a form | >95% |
| | | | of particles or flakes, other | |
| | | | appearance features were | |
| | | | similar to those of the | |
| | | | commercial polypropylene. | |
| Example 5 | 2.01 g | N/A | The shape was in a form of | N/A |
| | | | particles or flakes, and the | |
| | | | color was gray and darker than | |
| | | | that of the commercial | |
| | | | polypropylene. | |
| Example 6 | 2.05 g | N/A | The shape was in a form of | N/A |
| | | | particles or flakes, and the | |
| | | | color was gray and darker than | |
| | | | that of the commercial | |
| | | | polypropylene. | |
| Example 7 | 2.02 g | N/A | The shape was in a form of | N/A |
| | | | particles or flakes, and the | |
| | | | color was gray and darker than | |
| | | | that of the commercial | |
| | | | polypropylene. | |

As shown in the comparisons of Example 1 to Example 4, Example 1, which adopted xylene as the solvent and did not adopt non-solvent, had the highest recovery weight of polypropylene, which is 93.7% (the calculation formula is 2.81/3*100%). When the non-solvent was adopted to replace a part of the solvent, the recovery weights of polypropylene in Example 2 to Example reduced slightly, which indicated that the non-solvent can indeed replace the solvent and maintain a high recovery rate of polypropylene, even though polypropylene hardly dissolved in the non-solvent. Besides, the recovery rates of the solvent in Example 1 to Example 4 were all higher than 90%, or even higher than 95%, which indicated that the loss of the solvent was extremely low. Further, after the confirmation by Fourier-transform infrared spectroscopy (FTIR), the recovered products obtained in Example 1 to Example 4 had the signals the same as those of the commercial polypropylene, which indicated that the present invention can indeed effectively recover polypropylene. Finally, the original amounts of polypropylene in the industrial waste containing polypropylene in Example 5 to Example 7 were unknown, so the same recycling method was carried out three times and were shown as Example 5 to Example 7. As the colors of the recovered polypropylene in Example 5 to Example 7 were gray and darker than those of the commercial polypropylene, the probable cause may be that the recovered polypropylene in Example 5 to Example 7 were not pure polypropylene, and contained other ingredients soluble in xylene.

### Example 8 to Example 11

The materials containing plastics in the form of particles in Example 8 to Example 11 were commercial polypropylene. The experimental methods of Example 8 to Example 11 were similar to those of Example 1 to Example 7, except the following differences: (1) the amounts of commercial polypropylene in Example 8 to Example 11 were 0.8 g; (2) the solvents in Example 8 to Example 11 were all 100 ml of xylene; and (3) the volume ratios of the solvent and the non-solvent in Example 8 to Example 11 were all 1:1.

TABLE 4
the solvent and the non-solvent in Example 8 to Example 11

| | | Recovery | Recovery |
|---|---|---|---|
| | | rate of | rate of the solvent |
| Group | Non-solvent | polypropylene | and the non-solvent |
| Example 8 | propylene glycol | 95% | 85% |
| | methyl ether acetate | | |
| Example 9 | butyl acetate | 96% | 75% |
| Example 10 | isoamyl acetate | 94% | 85% |
| Example 11 | cyclohexanone | 95% | 90% |

As shown in Table 4, when the non-solvents were propylene glycol methyl ether acetate, butyl acetate, isoamyl acetate and cyclohexanone, the recovery rate of polypropylene in Example 8 to Example 11 were all higher than 94%. Further, Example 9, which adopted butyl acetate as the non-solvent, had the highest recovery rate of polypropylene, which reached 96%. However, Example 9 had the lowest recovery rate of the solvent and the non-solvent, which was 75% only. In addition, the non-solvents in Example 3 and Example 11 were both cyclohexanone, the volume ratios of xylene and cyclohexanone in Example 3 and Example 11 were both 1:1, and the total volumes of the solvent and non-solvent in Example 3 and Example 11 were both 200 ml. While the recovery rate of polypropylene in Example 3 was 92.7%, which was slightly lower than that of 95% in Example 11, the original amount of commercial polypropylene in Example 3 was 3 g, which was much higher than that of 0.8 g in Example 11, one may find that Example 3 demonstrated a more cost-effective recycling result, as 2.78 g (3 g*92.7%) of the recovered PP in Example 3 was much higher than that of 0.076 g (0.8 g*95%) in Example 11. Hence, more recovery amounts of polypropylene can be obtained when polypropylene was in a weight percentage (W/V) of 2.78 g/200 ml, which was close to 1.5 g/100 ml.

To sum up, the plastic recycling process of the present invention indeed has a high plastic recovery rate, and the solvent and the non-solvent are both reusable and can be recycled in high percentage, which reduces the cost and avoids potential environmental problems.

What is claimed is:

1. A plastic recycling process, comprising:
(1) preparation step: providing a material containing plastics, wherein the material containing plastics comprises a plastic ingredient, and the plastic ingredient comprises polypropylene (PP);
(2) mixing step: mixing the material containing plastics and a solvent to obtain a first mixture, wherein the plastic ingredient is soluble in the solvent;
(3) heating step: heating and stirring the first mixture at a temperature of 80° C. to 140° C. to dissolve the plastic ingredient in the solvent, thereby obtaining a dissolved liquid; and
(4) separation step: putting the dissolved liquid in a negative pressure environment to obtain the plastic ingredient.

2. The plastic recycling process as claimed in claim 1, wherein the separation step further comprises: keeping the dissolved liquid at a temperature of 70° C. to 100° C.

3. The plastic recycling process as claimed in claim 1, wherein the solvent comprises an aromatic hydrocarbon, a ketone, an ether, a naphthene hydrocarbon, an ester or a combination thereof.

4. The plastic recycling process as claimed in claim 3, wherein the aromatic hydrocarbon comprises benzole, toluene, xylene, tetralin, decalin or a combination thereof.

5. The plastic recycling process as claimed in claim 1, wherein the mixing step further comprises: adding a non-solvent, and the non-solvent comprises an ether, a ketone, an ester or a combination thereof.

6. The plastic recycling process as claimed in claim 5, wherein the ether comprises tetrahydrofuran; the ketone comprises cyclohexanone, acetone or a combination thereof; and the ester comprises propylene glycol methyl ether acetate, butyl acetate, isoamyl acetate or a combination thereof.

7. The plastic recycling process as claimed in claim 5, wherein based on the total volume of the solvent and the non-solvent, the solvent is in a volume of 45 volume percent to 60 volume percent, and the non-solvent is in a volume of 40 volume percent to 55 volume percent.

8. The plastic recycling process as claimed in claim 1, wherein the material containing plastics is in a form of particles, and the average diameter of the material containing plastics is greater than 0 mm and less than or equal to 5 mm; the stirring in the heating step is conducted at a speed of 15 rpm to 40 rpm for 15 minutes to 60 minutes, and the pressure of the negative pressure environment is greater than or equal to 0 mbar and less than or equal to 90 mbar.

9. The plastic recycling process as claimed in claim 1, wherein based on a volume of 100 ml of the solvent, the weight of the material containing plastics is greater than 0 g and less than or equal to 2.2 g.

10. The plastic recycling process as claimed in claim 5, wherein based on a total volume of 100 ml of the solvent and the non-solvent, the weight of the material containing plastics is greater than 0 g and less than or equal to 2.2 g.
